(19) United States
(12) Patent Application Publication
(10) Pub. No.: US 2010/0180184 A1
(43) Pub. Date: Jul. 15, 2010

(54) ALBUM EDITING APPARATUS, ALBUM EDITING METHOD, AND STORAGE MEDIUM

(75) Inventor: Yoshinobu Kitamaru, Ealing (GB)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/685,501

(22) Filed: Jan. 11, 2010

(30) Foreign Application Priority Data
Jan. 13, 2009 (JP) 2009-005117

(51) Int. Cl. G06F 17/21

(52) U.S. Cl. 715/204

(57) ABSTRACT

The present invention is directed to enabling a user to easily confirm errors that are generated when an electronic album is created in which a mixture of text and images is laid out on a plurality of pages. An apparatus according to the present invention automatically switches whether to display a text entry field on a list or a dialog screen according to a type of a page on which the text entry field exists and an entry status.

### BACKGROUND OF THE INVENTION

1. Field of the Invention

The present invention relates to a technique for laying out object data such as text data and image data on a page and editing an electronic album.

2. Description of the Related Art

Conventionally, a user creates an electronic album by arbitrarily laying out on a page images that the user has captured using a digital camera or text that the user has input using a keyboard. The created electronic album can be printed out and bound into a book by a professional vendor. Since such an electronic album includes a large number of images and texts over a plurality of pages, errors contained thereon are often overlooked. The user may thus realize that there are errors after the electronic album is delivered to him or printed.

### SUMMARY OF THE INVENTION

The present invention is directed to enabling a user to easily confirm errors that are generated when an electronic album is created in which a mixture of texts and images is laid out on a plurality of pages.

According to an aspect of the present invention, an apparatus which edits an electronic album in which a mixture of images and text is laid out on a plurality of pages includes an extracting unit configured to extract, when there is an instruction to confirm the electronic album, a text entry field from image entry fields and text entry fields existing on a body page, a determining unit configured to determine whether text is entered in the text entry field, and a displaying unit configured to display a list which includes the text entry field on the body page in which the text is determined to have been entered and text entry fields existing on a front cover page.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a confirmation screen according to an exemplary embodiment of the present invention.

FIG. 2 illustrates a configuration example of an album editing system according to the exemplary embodiment of the present invention.

FIG. 3 illustrates a configuration example of software and hardware according to the exemplary embodiment of the present invention.

FIG. 4 illustrates an example of a computer apparatus according to the exemplary embodiment of the present invention.

FIGS. 5A and 5B illustrate flowcharts of an example of a process performed by an album editing apparatus for displaying a confirmation display dialog according to the exemplary embodiment of the present invention.

FIGS. 6A and 6B illustrate flowcharts of an example of text and image confirmation determination procedures performed by the album editing apparatus according to the exemplary embodiment of the present invention.

FIG. 7 illustrates an example of an editing screen according to the exemplary embodiment of the present invention.

FIG. 8 illustrates an example of the editing screen according to the exemplary embodiment of the present invention.

FIG. 9 illustrates an example of a correction request dialog according to the exemplary embodiment of the present invention.

### DESCRIPTION OF THE EMBODIMENTS

Various exemplary embodiments, features, and aspects of the invention will be described in detail below with reference to the drawings.

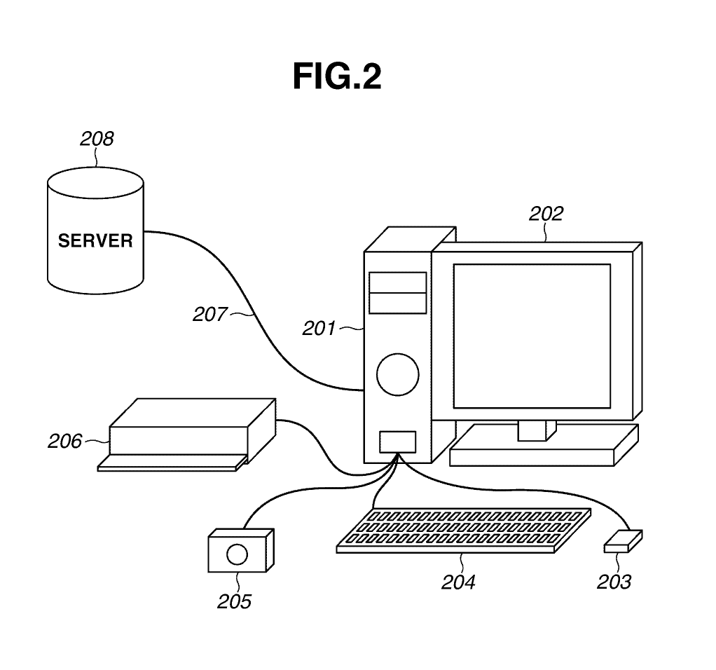

FIG. 2 illustrates a configuration example of an album editing system according to the exemplary embodiment of the present invention. Referring to FIG. 2, an album editing apparatus 201 according to the present exemplary embodiment is realized by a computer apparatus (i.e., an information processing apparatus).

The album editing system includes a display 202 which displays various data, a mouse 203 which is a typical pointing device, and a keyboard 204. A digital camera 205 (i.e., an imaging apparatus) is used to capture photographs. Such an imaging apparatus is not limited to the digital camera and can be any image input apparatus. The system also includes a printing apparatus 206. The album editing apparatus 201 can communicate with a web server apparatus 208 which receives an order to print an album via a network 207 which includes the Internet and a local area network (LAN).

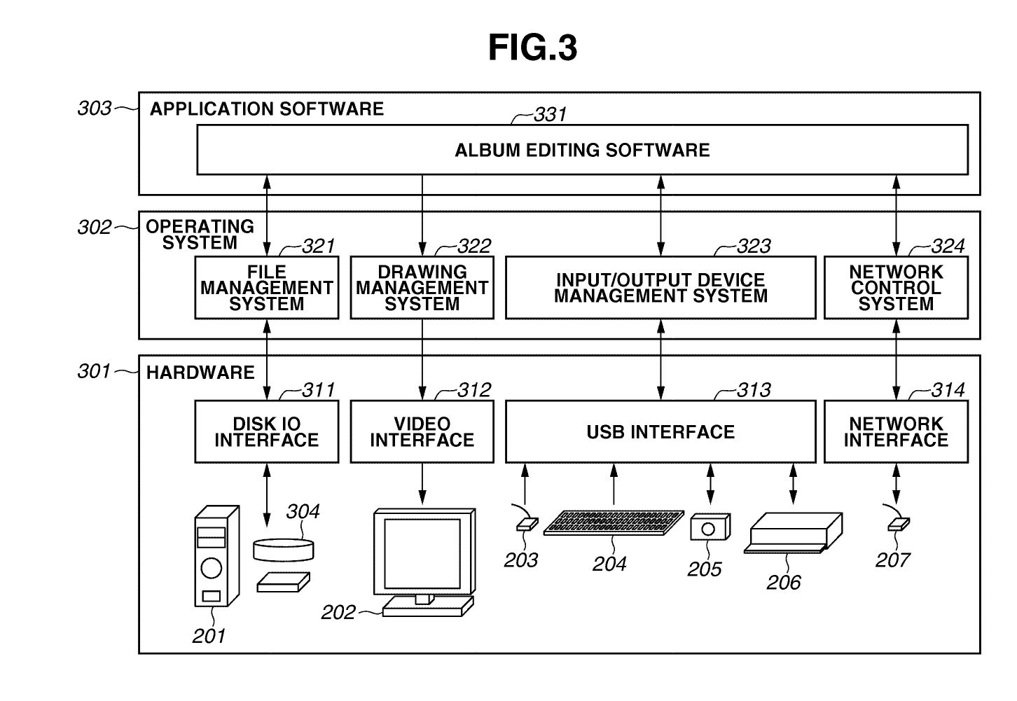

FIG. 3 illustrates a configuration example of software and hardware. Referring to FIG. 3, application software 303 runs on an operating system (OS) 302 which runs on hardware 301.

The application software 303 includes album editing software 331. A central processing unit (CPU, not illustrated) in the hardware 301 realizes the present exemplary embodiment by controlling each module according to the OS 302 and the application software 303 which the CPU reads out from a memory or a storage device 304.

Further, in FIG. 3, the storage device 304 such as a hard disk or a compact disk-rewritable (CD-RW) physically stores files and data inside the album editing apparatus 201. A file management system 321 which configures the OS 302 includes a function to allow the application software 303 to input and output files without regard to the hardware 301. The file management system 321 uses a disk input/output (I/O) interface 311 to read from and write into the storage device 304.

A drawing management system 322 which also configures the OS 302 includes a function for allowing the application software 303 to perform drawing without regard to the hardware 301. The drawing management system 322 uses a video interface 312 to perform drawing on the display 202.

An input/output device management system 323 which configures the OS 302 includes a function for allowing the application software to receive input from the digital camera 205 and output from the application software 303 without regard to the hardware 301. A universal serial bus (USB) interface 313 allows the input/output management system 323 to collectively manage input from the keyboard 204 and the mouse 203, input to and output from the digital camera 205, and input to and output from the printing apparatus 206.

A network control system 324 which configures the OS 302 includes a function for controlling the network so that the application software 303 can be executed without regard to the hardware 301. A network interface 314 allows the network control system 324 to communicate with devices on an external network via the network 207 which includes the Internet and the LAN.

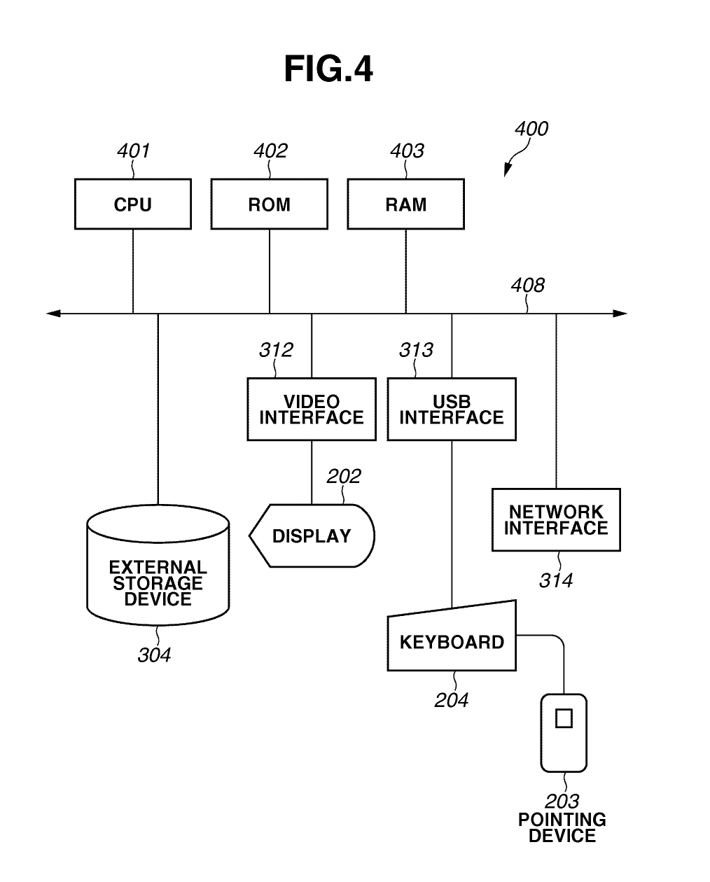

FIG. 4 illustrates an example of a hardware configuration of a computer apparatus 400 which realizes the album editing apparatus 201. The components which are similar to those in FIG. 3 will be assigned the same reference number as in FIG. 3.

A CPU 401 controls the entire computer apparatus 400. A read-only memory (ROM) 402 stores programs and parameters that do not require changes. A random access memory (RAM) 403 temporarily stores programs and data supplied from external devices.

The storage device 304 includes a hard disk fixedly installed in the computer apparatus 400 and a memory card. The storage device 304 stores the OS and the application software such as the album editing software.

The interface 313 interfaces the computer apparatus 400 with input devices such as the pointing device 203 and the keyboard 202 which receive an operation by the operator. The interface 312 interfaces the computer apparatus 400 with the display 202 which displays the data stored in the computer apparatus 400 or supplied data. The network interface 314 connects the computer apparatus 400 to the network 207 such as the Internet. A system bus 408 connects each of the units 401 to 403 and 311 to 314 in the computer apparatus 400 to be communicable with each other.

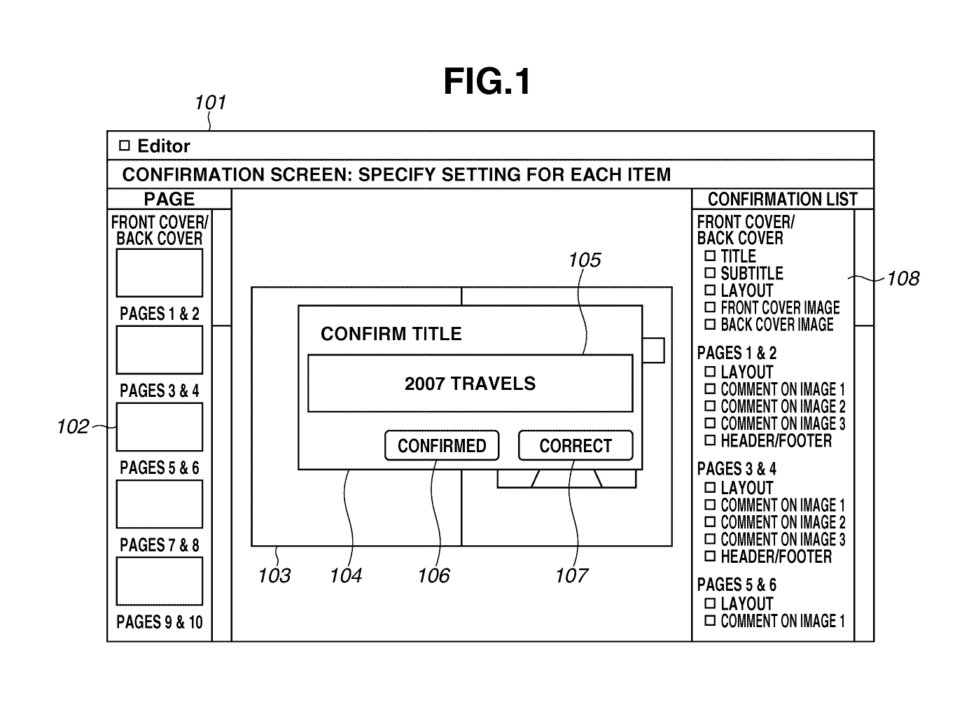

A representative example of a confirmation screen according to the present exemplary embodiment will be described below with reference to FIG. 1. Referring to FIG. 1, a confirmation screen 101 is displayed on the display 202.

A thumbnail display area 102 which displays a list of thumbnails for each page in the album is disposed on the left side of the confirmation screen 101. An operator can confirm page layouts of the entire album using the thumbnail display area 102. A page display area 103 displays each of the pages in the album. An enlarged view of the page corresponding to one of a plurality of thumbnails displayed on the thumbnail display area 102 is displayed on the page display area 103.

Further, an item laid out on the page which is to be confirmed (i.e., confirmation items) is displayed on a confirmation display dialog 104, so that the operator can confirm the items. The confirmation items are dynamically determined according to contents, a type, and a location of the item. The determination method will be described below.

A confirmation display area 105 displays the confirmation item. The confirmation item is enlarged on the confirmation display area 105, so that the operator can easily confirm the image data and the text data set to the confirmation item. For example, the operator can more accurately confirm typographical errors and omissions in the text entered in a text entry field, or whether the image is correctly trimmed. Errors can thus be prevented. If a display size of the confirmation item in the page display area 103 is sufficiently larger than a predetermined size, it is not necessary to enlarge the confirmation item when the confirmation item is displayed on the confirmation display area 105.

If the operator confirms that the item is correct, the operator presses a confirmed button 106. In response, the next confirmation item is displayed on the confirmation display area 105, and the operator continues the confirmation. The confirmation items are sequentially displayed on the confirmation display dialog 104, and the operator can confirm the confirmation items laid out on all pages in order.

Further, a confirmation list 108 which is a list of confirmation items and contents set to the confirmation items is displayed on the confirmation screen. The operator can thus easily view progress of the confirmation.

If the operator confirms that the item is not correct, the operator presses a correct button 107. In response to receiving the correction request, the confirmation screen is switched to an editing screen which receives a correction instruction from the operator, and the confirmation item with the error is then corrected. Otherwise, the confirmation item displayed when the operator pressed the correct button 107 is stored, and after all the confirmation items have been confirmed, the confirmation screen is switched to the editing screen. The instructions to correct the errors are then collectively received for the stored confirmation items, and the errors are then corrected.

In the present exemplary embodiment, the confirmation display dialog 104 displays only the items that satisfy a predetermined condition instead of displaying all items laid out on a page of the album. As a result, the operator can focus on confirming the items in which the operator tends to make a mistake or items in which errors can become conspicuous. Further, a load on the operator such as time spent on the confirmation can be reduced as compared to when the operator confirms all items.

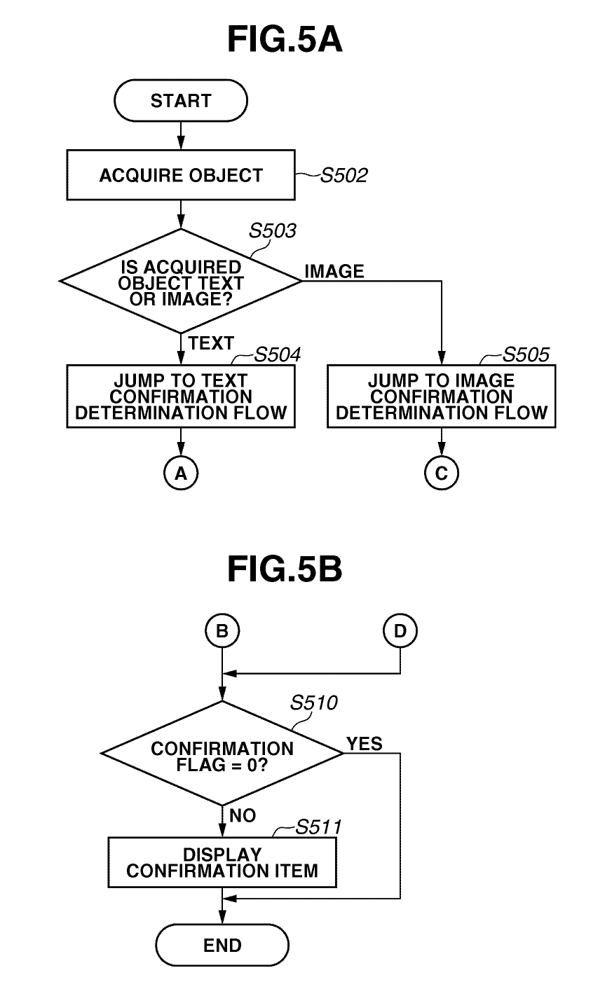

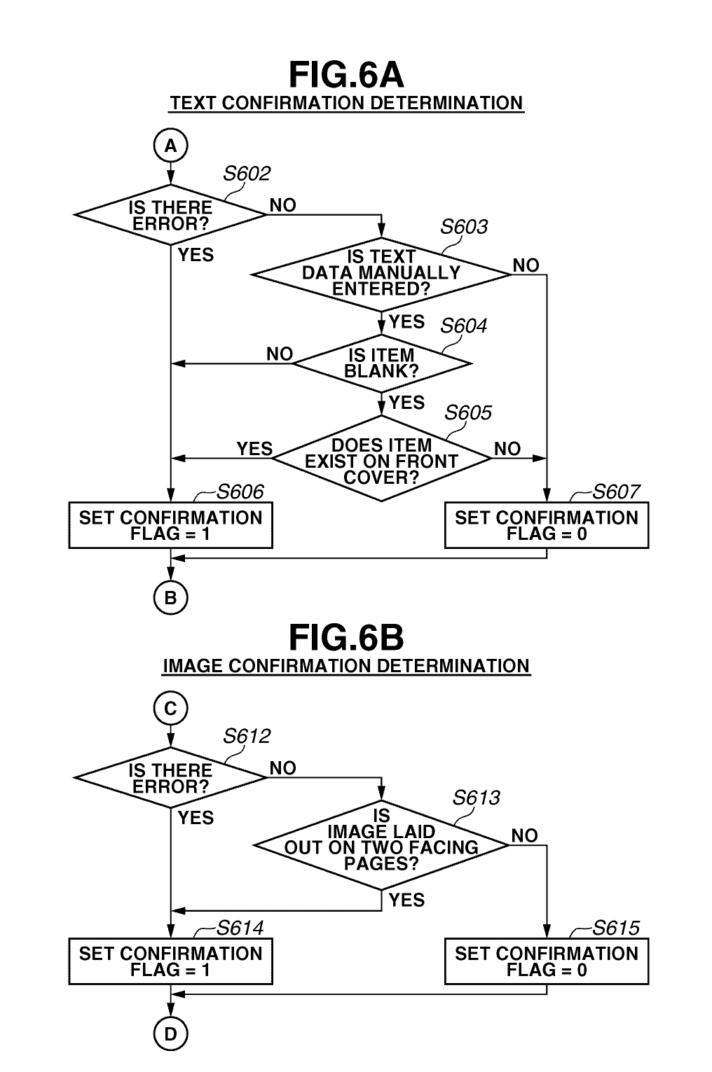

The processes performed by the album editing apparatus 201 for displaying the confirmation display dialog 104 will be described below with reference to FIGS. 5A, 5B, 6A, and 6B.

In an initial state, the album editing software 331 is running on the album editing apparatus 201, and the editing screen is displayed on the display 202. Upon receiving an input from the operator on the editing screen, the album editing apparatus 201 sets the image data and the text data to each item on each page in the album, such as a cover page, a body page, and a back cover. The items are then laid out, and the album is created. Further, background images and background colors can be set to the album.

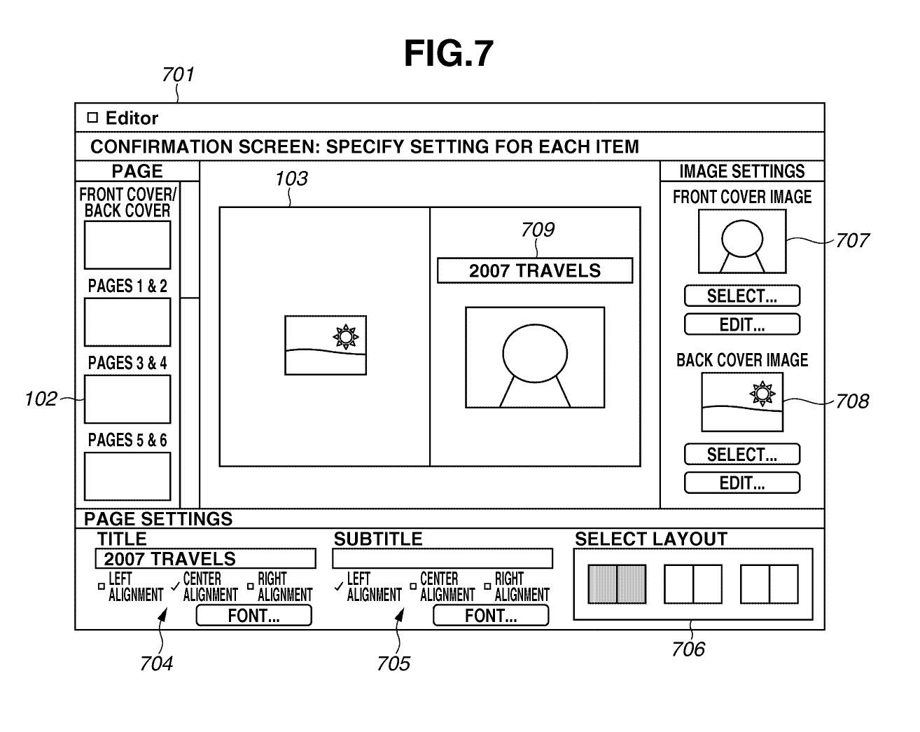

FIG. 7 illustrates an example of an editing screen 701. The components which are the same as those in the confirmation screen illustrated in FIG. 1 are assigned the same reference numbers and further description is omitted.

Upon receiving an edit instruction, the album editing apparatus 201 displays the thumbnail display area 102 and the page display area 103 by reflecting results of editing in real time. The operator then creates the album by entering the text data and the image data to the items and correcting the entered contents while viewing the page display area 103.

Referring to FIG. 7, entry areas 704 and 705 are areas for entering a title and a subtitle respectively. The text data entered in the entry area 704 is laid out in a title 709 and displayed.

In the example illustrated in FIG. 7, the cover page is displayed on the page display area 103. If the body page is displayed on the page display area 103, the operator can enter a page header and footer, a head title of a paragraph, and comments on each image. The entered text data is then reflected to the page display area 103.

A layout selection area 706 displays several layout templates, and the layout of the images and texts changes according to the layout selected by the operator.

Image entry areas 707 and 708 are areas for entering the images to be set to the front cover and the back cover. The image data selected in the image entry areas 707 and 708 are set to the front cover and the back cover and displayed on the page display area 103.

Referring to FIG. 5A, in step S502, the album editing apparatus 201 acquires an object set to the item in response to a confirm instruction input by the operator. In step S503, the album editing apparatus 201 determines whether the object is the text data or the image data.

If the acquired object is the text data (TEXT in step S503), the process proceeds to step S504 in which the album editing apparatus 201 jumps to a text confirmation determination flow. The text confirmation determination flow will be described in detail below with reference to FIG. 6A.

On the other hand, if the object acquired in step S502 is the image data (IMAGE in step S503), the process proceeds to step S505 in which the album editing apparatus 201 jumps to an image confirmation determination flow. The image confirmation determination flow will be described in detail below with reference to FIG. 6B.

In step S510 illustrated in FIG. 5B, the album editing apparatus 201 determines whether the item is a confirmation item. If a confirmation flag is not set to “0” (NO in step S510), the process proceeds to step S511. Instep S511, the album editing apparatus 201 displays the item on the confirmation item dialog 104. If the confirmation flag is set to “0” (YES in step S510), the album editing apparatus 201 does not display the item on the confirmation item dialog 104, and the process ends.

The confirmation display dialog 104 displayed in step S511 then terminates the processing of the item by responding to the operator pressing the confirmed button 106 or the correct button 107. The process is similarly repeated for the rest of the items.

The text confirmation determination process will be described in detail below with reference to FIG. 6A.

In step S602, the album editing apparatus 201 analyzes the text data and determines whether there is an error. For example, the album editing apparatus 201 determines that there is an error if the result of the analysis using a conventional text recognition tool indicates that the text data includes typographical errors and omissions, discontinuity and overflow of the text, or characters which are not permitted to be used.

If there is an error (YES in step S602), the process proceeds to step S606, and the album editing apparatus 201 sets the confirmation flag to “1”. The process then proceeds to step S510.

On the other hand, if there is no error (NO in step S602), the process proceeds to step S603. In step S603, the album editing apparatus 201 determines whether the text data set to the item is arbitrary information which is manually entered by the operator.

If the text data has been not manually entered, but automatically entered such as by reading and entering image capture information of the image data (NO in step S603), the possibility of errors is low. The album editing apparatus 201 can thus determine that it is not necessary to make a confirmation, so that the process proceeds to step S607 in which the album editing apparatus 201 sets the confirmation flag to “0”.

When the text data is read from the image data and automatically entered, an automatic entry flag is updated from “0”, i.e., an initial value, to “1”. In step S603, the album editing apparatus 201 refers to the automatic entry flag and determines whether the text data is manually entered.

On the other hand, if the text data has been manually entered (YES in step S603), the process proceeds to step S604 in which the album editing apparatus 201 determines whether the item is blank. If the item is not blank (NO in step S604), the process proceeds to step S606 in which the album editing apparatus 201 set the confirmation flag to “1”. Since it is highly possible that the text data manually entered by the operator and set to the item contains an error, the album editing apparatus 201 may cause the operator to make the confirmation by using the confirmation display dialog.

On the other hand, if the item is blank (YES in step S604), the process proceeds to step S605. In step S605, the album editing apparatus 201 determines whether the item exists on the cover page. If the item exists on the cover page (YES in step S605), the process proceeds to step S606 in which the album editing apparatus 201 sets the confirmation flag to “1”. The item is thus displayed on the confirmation display dialog even when the item is blank, and the album editing apparatus 201 can cause the operator to confirm whether the item is allowed to be blank for an important item such as an album title on the cover page.

If the item exists on the body page instead of the cover page (NO in step S605), it is likely that the text data is not required to be set to the item. The process then proceeds to step S607 in which the album editing apparatus 201 sets the confirmation flag to “0”. An example of such an item is a comment assigned to each image laid out on the body page which is often purposely omitted by the operator. The album editing apparatus 201 thus sets to each item whether the confirmation is necessary based on the content of the text data input to the item and the type and location of the item in the album. Further, the album editing apparatus 201 performs control of displaying and hiding of the confirmation display dialog for each item.

The image confirmation determination flow will be described below with reference to FIG. 6B.

In step S612, the album editing apparatus 201 analyzes the image data and determines whether there is an error. For example, if a red-eye or an overexposure is detected in the image data by using a conventional image recognition tool, the album editing apparatus 201 determines that there is an error. If there is an error (YES in step S612), the process proceeds to step S614 and the album editing apparatus 201 sets the confirmation flag to “1”.

On the other hand, if there is no error (NO in step S612), the process proceeds to step S613. In step S613, the album editing apparatus 201 determines whether the image data is laid out on two facing pages. If the image data is laid out on two facing pages (YES in step S613), the process proceeds to step S614 in which the album editing apparatus 201 sets the confirmation flag to “1”. For example, when the image data is laid out on two facing pages, a portion of the image data may overlap with a binding margin and become hidden when the album is bound, so that the visual quality may become degraded. Therefore, it becomes necessary to cause the operator to perform the confirmation. If the image is not laid out over two facing pages (NO in step S613), the process proceeds to step S615 in which the album editing apparatus 201 sets the confirmation flag to “0”.

The determination of whether the required item is blank can also be performed in the image confirmation flow similarly as in the text confirmation flow. For example, a confirmation can be performed when an image is not set to the cover page.

In the above described exemplary embodiment, the confirmation flag is set to “1” or “0” to control displaying and hiding of the confirmation display dialog. A case where a display form, such as color, of the confirmation display dialog is changed for displaying the confirmation display dialog will be described below.

For example, if the determination result in step S602 in the text confirmation determination flow illustrated in FIG. 6A is “YES”, the possibility of an error is high. The album editing apparatus 201 then sets the confirmation flag to “1.0”. Further, if the determination result in step S604 is “NO”, the possibility of an error is low, so that the album editing apparatus 201 sets the confirmation flag to “0.8”. Furthermore, if the determination result in step S605 is “YES”, the possibility of an error is very low, so that the album editing apparatus 201 sets the confirmation flag to “0.6”. The color of the confirmation display dialog 104 is then changed using the setting values of the confirmation flag.

For example, a display color is previously managed for each setting value, such as “value of confirmation flag is 1.0: red”, “value of confirmation flag is 0.8: orange”, and “value of confirmation flag is 0.6: yellow”. The display of the confirmation display dialog 104 is then controlled according to the above display colors. Since a degree of the error can be intuitively displayed to the operator by changing the color of the confirmation display dialog 104, the album editing apparatus 201 can alert the operator according to the level of the possibility of an error. The operator can avoid overlooking the errors.

The process performed by the album editing apparatus 201 when the operator presses the correct button 107 in the confirmation display dialog 104 will be described below. The process will be described for each of two cases.

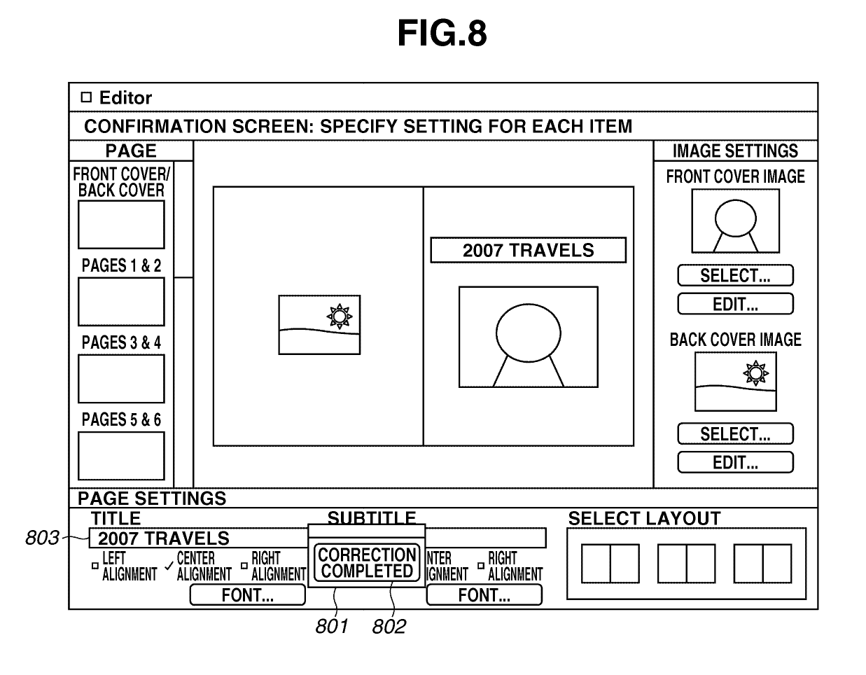

Ina first case, when the operator presses the correct button 107, the confirmation screen is immediately switched to the editing screen. The album editing apparatus 201 then receives a correction request and acquires and stores identification information of the item displayed on the confirmation display dialog 104. The album editing apparatus 201 hides the confirmation display dialog 104 and switches the display from the confirmation screen to the editing screen illustrated in FIG. 8.

Referring to FIG. 8, there is a focus on a character string “2007 travels” in an entry area 803 for entering the item displayed on the confirmation display dialog 104 when the operator clicked the correct button 107. The operator can thus be smoothly guided to the item to be corrected.

The operator then corrects the character string to “2008 travels” which is the correct title and clicks a “correction completed” button 802. The album editing apparatus 201 then receives a correction completion request and switches the display back to the confirmation screen. The album editing apparatus 201 displays on the confirmation display dialog 104 the next item in the correction items which have been stored when the correction request was received. The confirmation on the rest of the items is then continued.

When the operator confirms that it is not necessary to correct the item, the operator clicks the confirmed button 106. The album editing apparatus 201 then displays the next item on the confirmation display dialog 104. By repeating such a process, the operator can immediately correct the erroneous portion and create an error-free album.

Next, a case where the album editing apparatus 201 stores the identification information of the items on which the operator pressed the correct button 107 and collectively corrects the items which need to be corrected after all of the items in the album are confirmed will be described below.

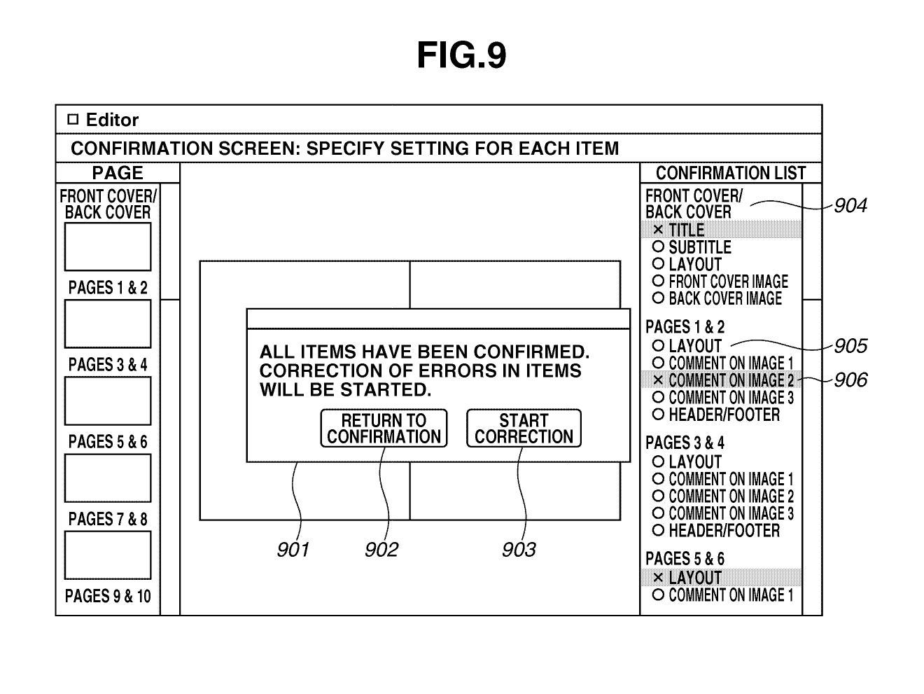

FIG. 9 illustrates an example of a correction request dialog 901 which is displayed when the operator finishes the confirmation of the final item of all confirmation items displayed on the confirmation display dialog 104 by pressing either the confirmed button 106 or the correct button 107. A button 902 is a button for returning to the confirmation screen for confirming the confirmation item, and a button 903 is a button for starting the correction process.

When the operator clicks the confirmed button 106, the confirmation flag is updated from “1” to “0”. A list 904 displays the confirmation results. An item 905 in which there is no error as a result of the confirmation, i.e., the confirmation flag is updated to “0” after the operator has confirmed the item is displayed with a mark indicating that there is no error on a head of the item. An item 906 that the operator requested to correct, i.e., the confirmation flag is kept set to “1”, is highlighted and displayed with a mark indicating that there is an error on the head of the item.

If the operator then clicks the button 903 to start the correction, the entry areas of only the items with the mark indicating that there is an error, i.e., the items whose confirmation flag is set to “1”, are sequentially displayed in on the editing screen illustrated in FIG. 8. When the operator finishes editing, the album editing apparatus 201 switches the display from the editing screen to the confirmation screen and sequentially displays the correction items on the confirmation display dialog. The operator can then resume the confirmation.

More specifically, only the correction items are further confirmed among the confirmation items, so that the operator can again confirm whether there is an error and create an album with less error. Further, since the operator does not confirm the items which do not require correction among the confirmation items, the operator is relieved from reconfirming the correct confirmation items.

As described above, according to the present exemplary embodiment, the confirmation items among the items contained in the album are displayed on the confirmation display dialog. Therefore, it can prevent the operator from neglecting to confirm an important. Further, the confirmation items can be selected based on the type and the location of the item and the content of the data set to the item. The operator can thus focus on confirming the items which are highly possible to include an error, and a high quality album can be created efficiently.

Aspects of the present invention can also be realized by a computer of a system or apparatus (or devices such as a CPU or MPU) that reads out and executes a program recorded on a computer-readable storage medium to perform the functions of the above-described embodiment(s), and by a method, the steps of which are performed by a computer of a system or apparatus by, for example, reading out and executing a program recorded on a computer-readable storage medium to perform the functions of the above-described embodiment(s). For this purpose, the program is provided to the computer for example via a network or from a computer-readable storage medium of various types serving as the memory device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-005117 filed Jan. 13, 2009 which is hereby incorporated by reference herein in its entirety.

What is claimed is:

1. An apparatus which edits an electronic albumin which a mixture of images and text is laid out on a plurality of pages, the apparatus comprising:
an extracting unit configured to extract, when there is an instruction to confirm the electronic album, a text entry field from image entry fields and text entry fields existing on a body page;
a determining unit configured to determine whether text is entered in the text entry field; and
a displaying unit configured to display a list which includes the text entry field on the body page in which the text is determined to have been entered and text entry fields existing on a front cover page.

2. The apparatus according to claim 1,
wherein said determining unit further determines whether the text is manually entered in the text entry field; and
wherein said displaying unit displays, if the text is manually entered, the text entry field in the list.

3. The apparatus according to claim 1,
wherein said determining unit further determines whether there is an error in text entered in the text entry field; and
wherein said displaying unit displays, if there is an error in the text, the text entry field in the list.

4. The apparatus according to claim 1, wherein said displaying unit displays text entered in the text entry field in a list.

5. An apparatus which edits an electronic albumin which a mixture of images and text is laid out on a plurality of pages, the apparatus comprising:
an extraction unit configured to extract, when there is an instruction to confirm the electronic album, a text entry field from image entry fields and text entry fields existing on a body page;
a determination unit configured to determine whether text is entered in the text entry field;
a layout display unit configured to lay out the images and the text on the body page or a displayed page and display the page on a layout screen; and
a dialog display unit configured to display a dialog screen for entering text in the text entry field on the body page in which the text is determined to have been entered and text entry fields existing on a front cover page and to display the text entry field on the dialog screen in a larger size than a size when the text entry field is displayed on the layout screen.

6. The apparatus according to claim 5, wherein said determining unit further determines whether the text is manually entered in the text entry field; and
said dialog display unit displays, if the text is manually entered, the text entry field in the dialog screen.

7. The apparatus according to claim 1, wherein said determining unit further determines whether there is an error in text entered in the text entry field; and
said dialog display unit displays, if there is an error in the text, the text entry field in the dialog screen.

8. The apparatus according to claim 5, wherein the text entry field is weighted, and when the dialog screen is displayed, the text entry field is displayed thereon in a display mode according to the weight.

9. A method for editing an electronic album in which a mixture of images and text is laid out on a plurality of pages comprising:
extracting, when there is an instruction to confirm an electronic album, a text entry field from image entry fields and text entry fields existing on a body page;
determining whether text is entered in the text entry field; and
displaying a list which includes the text entry field on the body page in which the text is determined to have been entered and text entry fields existing on a front cover page.

10. A computer-readable storage medium storing a program, wherein the program executes the method of claim 9.

11. A method for editing an electronic album in which a mixture of images and text is laid out on a plurality of pages comprising:
extracting, when there is an instruction to confirm an electronic album, a text entry field from image entry fields and text entry fields existing on a body page;
determining whether text is entered in the text entry field;
laying out the image and the text on the body page or the displayed page and displaying the page on a layout screen; and
displaying a dialog screen for entering text in the text entry field on the body page in which the text is determined to have been entered and text entry fields existing on a front cover page and displaying the text entry field on the dialog screen in a larger size than a size when the text entry field is displayed on the layout screen.

12. A computer-readable storage medium storing a program, wherein the program executes the method of claim 11.
